(19) United States
(12) Patent Application Publication
(10) Pub. No.: US 2026/0087933 A1
(43) Pub. Date: Mar. 26, 2026

(54) AIRCRAFT GROUND COORDINATED TURNING SYSTEM AND SLIDING MODE CONTROL METHOD AND SYSTEM THEREOF

(71) Applicants: NINGBO INSTITUTE OF MATERIALS TECHNOLOGY AND ENGINEERING, CHINESE ACADEMY OF SCIENCES, Ningbo (CN); QIANWAN INSTITUTE OF CNITECH, Ningbo (CN)

(72) Inventors: Wenxiao HU, Ningbo (CN); Yepeng HAN, Ningbo (CN); Hang GE, Ningbo (CN); Xinmin CHEN, Ningbo (CN)

(73) Assignees: NINGBO INSTITUTE OF MATERIALS TECHNOLOGY AND ENGINEERING, CHINESE ACADEMY OF SCIENCES, Ningbo (CN); QIANWAN INSTITUTE OF CNITECH, Ningbo (CN)

(21) Appl. No.: 19/221,018

(22) Filed: May 28, 2025

(30) Foreign Application Priority Data
Sep. 23, 2024 (CN) 2024113254476

(51) Int. Cl. G08G 5/51

(52) U.S. Cl. CPC G08G 5/51

(57) ABSTRACT

This application addresses the problems of large runway space occupation and potential airport traffic congestion during turning in current aircraft ground coordinated turning control methods. It proposes an aircraft ground coordinated turning system, and a sliding mode control method and system thereof. Based on real-time parameters of an aircraft, the state of the aircraft ground coordinated turning system is controlled on a composite sliding mode surface for nose wheel-main wheel coordinated turning through a nose wheel-main wheel coordinated turning control law. Specifically, a model for the aircraft ground coordinated turning system is developed. Aiming at the control problem in the traditional aircraft ground turning phase, and considering the problems such as oversteering of the nose landing gear and a large turning radius in the traditional nose wheel steering technology. Through coordinated turning of the nose wheel and main wheels, the turning radius is effectively reduced.

### CROSS-REFERENCE TO RELATED APPLICATIONS

The application claims priority to Chinese patent application No. 2024113254476, filed on Sep. 23, 2024, the entire contents of which are incorporated herein by reference.

### TECHNICAL FIELD

The present application belongs to a sliding mode control method, and particularly relates to an aircraft ground coordinated turning system and a sliding mode control method and system thereof.

### BACKGROUND

The characteristics of aircraft ground taxiing are crucial for flight safety during the takeoff and landing phases. Relevant statistics show that 49% of all aircraft accidents occur during these phases, making them the most accident-prone stages of flight.

Currently, research on aircraft take-off and landing phases primarily focuses on the area of aircraft anti-skid brake control. There has been relatively little research on aircraft ground coordinated turning control, with relevant studies mainly concentrating on steering via the nose wheel, differential thrust steering using engine power, and differential braking steering of the main wheels. In practical applications, steering via the nose wheel is predominantly used for aircraft ground turning. However, this method has shortcomings such as over-steering of the nose landing gear and a large turning radius, which can lead to the occupation of significant runway space during turning, further causing airport traffic congestion.

### SUMMARY

The present application addresses the technical problems of large runway space occupation and potential airport traffic congestion during turning in the current aircraft ground coordinated turning control method, and provides an aircraft ground coordinated turning system and a sliding mode control method and system thereof.

In order to achieve the above objective, the present application adopts the following technical solutions:

In a first aspect, the application provides a sliding mode control method of an aircraft ground coordinated turning system, including:
acquiring real-time parameters of an aircraft; and
controlling a state of the aircraft ground coordinated turning system on a composite sliding mode surface for nose-wheel-main-wheel coordinated turning by a nose-wheel-main-wheel coordinated turning control law based on the real-time parameters of the aircraft; wherein
the state of the aircraft ground coordinated turning system includes a steering angle of a left main wheel and a right main wheel, and a steering angle of a nose wheel;
a control target of the composite sliding mode surface for nose-wheel-main-wheel coordinated turning is that a yaw distance of the aircraft and a yaw angle of the aircraft approach zero within a preset time; and
an acquisition method of the nose-wheel-main-wheel coordinated turning control law includes:
taking a derivative of the composite sliding mode surface for nose-wheel-main-wheel coordinated turning, and in combination with a model of the aircraft ground coordinated turning system, determining a nose-wheel-main-wheel coordinated turning control law; wherein system state variables of the model of the aircraft ground coordinated turning system include a yaw distance of the aircraft, a yaw angle of the aircraft, a longitudinal velocity of the aircraft and a yaw angular velocity.

In a second aspect, the application provides a sliding mode control system of an aircraft ground coordinated turning system, including:
an acquisition module, configured to acquire real-time parameters of an aircraft;
a control module, configured to control a state of the aircraft ground coordinated turning system on a composite sliding mode surface for nose-wheel-main-wheel coordinated turning by a nose-wheel-main-wheel coordinated turning control law based on the real-time parameters of the aircraft; wherein
the state of the aircraft ground coordinated turning system includes a steering angle of a left main wheel and a right main wheel, and a steering angle of a nose wheel;
a control target of the composite sliding mode surface for nose-wheel-main-wheel coordinated turning is that a yaw distance of the aircraft and a yaw angle of the aircraft approach zero within a preset time; and
an acquisition method of the nose-wheel-main-wheel coordinated turning control law includes:
taking a derivative of the composite sliding mode surface for nose-wheel-main-wheel coordinated turning, and in combination with a model of the aircraft ground coordinated turning system, determining a nose-wheel-main-wheel coordinated turning control law; wherein system state variables of the model of the aircraft ground coordinated turning system include a yaw distance of the aircraft, a yaw angle of the aircraft, a longitudinal velocity of the aircraft and a yaw angular velocity.

In a third aspect, the present application proposes an aircraft ground coordinated turning system, including a controller and a body of the aircraft ground coordinated turning system; wherein the controller controls the body of the aircraft ground coordinated turning system according to the sliding mode control method of an aircraft ground coordinated turning system.

Compared with the prior art, the present application has the following beneficial effects:
the present application proposes a sliding mode control method of an aircraft ground coordinated turning system, the method controls the state of the aircraft ground coordinated turning system on a composite sliding mode surface for nose-wheel-main-wheel coordinated turning by a nose-wheel-main-wheel coordinated turning control law based on the real-time parameters of the aircraft. Specifically, a model for the aircraft ground coordinated turning system is developed. Aiming at the control problem in the traditional aircraft ground turning phase, and considering the problems such as oversteering of the nose landing gear and a large turning radius in the traditional nose wheel steering technology, a sliding mode control method of the aircraft ground coordinated turning system is introduced. Through coordinated turning of the nose wheel and main wheels, the turning radius is effectively reduced, thus enabling precise trajectory tracking during aircraft ground taxiing and ensuring flexible steering operations of the aircraft with a small radius.

The present application further proposes a sliding mode control system of an aircraft ground coordinated turning system, as well as the aircraft ground coordinated turning system itself, both of which possess all the advantages of the aforementioned sliding mode control method of the aircraft ground coordinated turning system.

### BRIEF DESCRIPTION OF DRAWINGS

To illustrate the technical solutions of the embodiments of the application more clearly, the drawings required for use in the embodiments will be briefly described below, it should be understood that the following drawings illustrate only certain embodiments of the present application and should not be regarded as limiting the scope, and that other related drawings can be obtained from these drawings without inventive step for those of ordinary skill in the art.

FIG. 1 is a first flow chart of a sliding mode control method of an aircraft ground coordinated turning system;

FIG. 2 is a second flow chart of a sliding mode control method of an aircraft ground coordinated turning system;

FIG. 3 is a schematic diagram of aircraft trajectory tracking according to an embodiment of the present disclosure;

FIG. 4 is a lateral force diagram of aircraft taxiing according to an embodiment of the present disclosure;

FIG. 5 is a top-view force diagram of aircraft taxiing according to an embodiment of the present disclosure;

FIG. 6 is a yaw distance graph for coordinated turning control under fixed initial conditions;

FIG. 7 is a yaw angle graph for coordinated turning control of an aircraft under fixed initial conditions;

FIG. 8 is a motion trajectory graph for coordinated turning control under fixed initial conditions;

FIG. 9 is a trajectory tracking graph for coordinated turning control at different longitudinal speeds;

FIG. 10 is a trajectory tracking graph for coordinated turning control at different initial yaw angles of an aircraft; and

FIG. 11 is a schematic diagram of a sliding mode control system of an aircraft ground coordinated turning system according to the present application.

### DETAILED DESCRIPTION OF THE EMBODIMENTS

In order to make the objectives, technical solutions and advantages of the embodiments of the present application more clear, the technical solutions in the embodiments of the present application will be clearly and completely described below in conjunction with the accompanying drawings in the embodiments of the present application, and it is obvious that the described embodiments are a part of the embodiments of the present application, rather than all of the embodiments. The components of the embodiments of the present application as generally described and illustrated in the figures herein could be arranged and designed in a wide variety of different configurations.

Thus, the following detailed description of embodiments of the application provided in the accompanying drawings is not intended to limit the scope of the claimed application, but is merely to represent selected embodiments of the application. Based on the embodiments in the present application, all other embodiments obtained by those skilled in the art without creative work fall within the scope of protection of the present application.

It should be noted that like reference numerals and letters represent like items in the following figures, and therefore, once an item is defined in one figure, it need not be further defined and explained in the subsequent figures.

In the description of the embodiments of the present application, it should be noted that if the orientation or positional relationship indicated by the terms “upper”, “lower”, “horizontal”, “inner”, etc. is based on the orientation or positional relationship shown in the drawings, or is the orientation or positional relationship usually placed when the product of the present disclosure is used, it is only for convenience and simplification of the description of the present application, and does not indicate or imply that the device or element referred to must have a specific orientation, be constructed and operated in a specific orientation, and therefore cannot be understood as a limitation of the present application. Furthermore, the terms “first”, “second”, etc. are merely used to distinguish descriptions and cannot be understood as indicating or implying relative importance.

When using nose wheel steering for aircraft ground turning, there is the problem of large runway space occupation during the turning process, which can easily lead to airport traffic congestion. The main reasons are as follows:

### (1) Limitations of Nose Wheel Steering.

Although nose wheel steering can control the direction of the aircraft on the ground, the turning radius is constrained by various factors such as aircraft size, weight, tire characteristics, and runway conditions. Large aircraft, due to their huge size and weight, typically require a larger turning radius to complete a turn, thereby occupying more runway space. During low-speed taxiing, the effect of nose wheel steering is more significant. However, as speed increases, the maximum steering angle of the nose wheel decreases, and the turning radius increases accordingly. Therefore, during high-speed taxiing or takeoff and landing, nose wheel steering has limited effectiveness in reducing the turning radius.

### (2) Airport Traffic Flow and Runway Utilization.

At airports, aircraft takeoffs, landings, and ground taxiing occur frequently, resulting in high traffic density. If each aircraft occupies a large amount of runway space during ground turning, it will exacerbate traffic congestion and affect the overall operational efficiency of the airport. Furthermore, the varying runway layouts and taxiway configurations at different airports will also influence the runway occupation during aircraft ground turning.

Based on the above situations, the present application proposes an aircraft ground coordinated turning system and a sliding mode control method and system thereof. Below, a detailed description of the present application is provided in conjunction with embodiments and accompanying drawings.

Aircraft ground coordinated turning is an important technology for performing turning operations during the ground taxiing phase, especially common in wide-body aircraft and large transport planes. This technology aims to enhance the flexibility and safety of aircraft during ground taxiing, reduce the turning radius, shorten taxiing time, and thereby improve airport operational efficiency. Below is a detailed analysis of aircraft ground coordinated turning:
aircraft ground coordinated turning refers to the process of achieving smooth turning for an aircraft during ground taxiing through the coordinated control of the steering angles of the tires on both the nose landing gear and the main landing gear. This requires precise calculation and control of parameters such as tire steering angles, taxiing speeds, and ground friction to ensure stability and safety during the turning process. By coordinating the steering angles of the tires on the nose landing gear and the main landing gear, the turning radius of the aircraft can be significantly reduced, enhancing its flexibility during ground taxiing.

The sliding mode control of an aircraft ground coordinated turning system is an advanced control strategy that combines the robustness of sliding mode control with the complexity of the aircraft ground coordinated turning system to achieve precise control and stability during aircraft ground taxiing. Wherein, the sliding mode control, also known as variable structure control, is a special nonlinear control method. It involves designing a sliding mode surface such that the system state continuously approaches this sliding mode surface during the dynamic process and engages in sliding mode motion on the sliding mode surface.

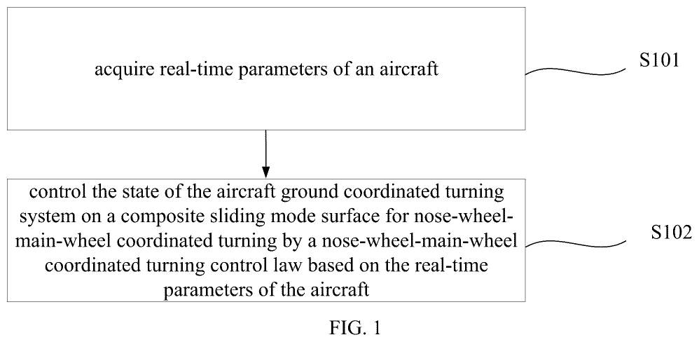

FIG. 1 is a first flow chart of a sliding mode control method of an aircraft ground coordinated turning system, which may include:

S101, real-time parameters of an aircraft are acquired.

In practical applications, when implementing sliding mode control for an aircraft ground coordinated turning system, it is necessary to obtain real-time parameters of the aircraft, such as its speed, attitude, position, and other relevant information. These real-time aircraft parameters can be acquired in real-time through various sensors and monitoring systems on the aircraft and transmitted to the controller of the aircraft. In practical applications, different real-time aircraft parameters may be based on different coordinate systems, and can be unified through conversions between coordinate systems.

S102, the state of the aircraft ground coordinated turning system is controlled on a composite sliding mode surface for nose-wheel-main-wheel coordinated turning by a nose-wheel-main-wheel coordinated turning control law based on the real-time parameters of the aircraft.

In sliding mode control, the sliding mode surface is a crucial element. The purpose of designing the sliding mode surface is to enable the system state to slide onto this sliding mode quickly and accurately, and to maintain its movement on this sliding mode surface. The design of the sliding mode surface depends on the properties of the system and the control target, which can be determined through mathematical modeling and analysis. The control law is another important component in sliding mode control. By reasonably designing the control law, high-precision control of the system state can be achieved.

The state of the aircraft ground coordinated turning system includes a steering angle of a left main wheel and a right main wheel, and a steering angle of a nose wheel. Through the coordination among the steering angles of the left and right main wheels and the nose wheel, precise control of the aircraft ground coordinated turning can be achieved, ensuring effective turning performance.

A control target of the composite sliding mode surface for nose-wheel-main-wheel coordinated turning is that a yaw distance of the aircraft and a yaw angle of the aircraft approach zero within a preset time.

An acquisition method of the nose-wheel-main-wheel coordinated turning control law includes:
a derivative of the composite sliding mode surface for nose-wheel-main-wheel coordinated turning is taken, and in combination with a model of the aircraft ground coordinated turning system, a nose-wheel-main-wheel coordinated turning control law is determined; wherein system state variables of the model of the aircraft ground coordinated turning system include a yaw distance of the aircraft, a yaw angle of the aircraft, a longitudinal velocity of the aircraft and a yaw angular velocity.

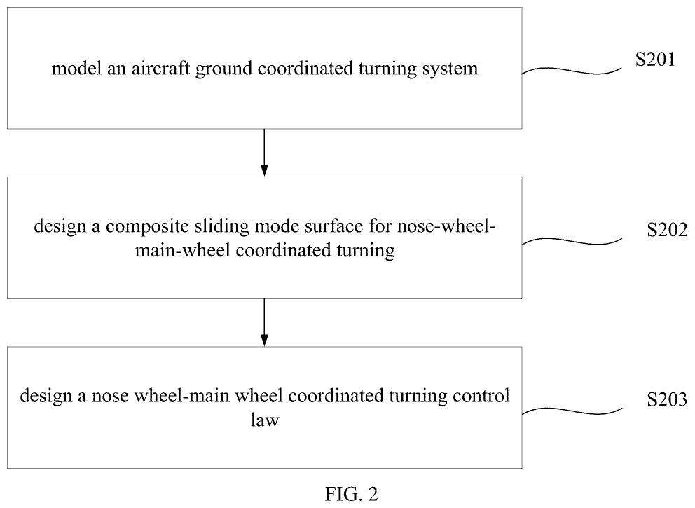

FIG. 2 is a second flow chart of a sliding mode control method of an aircraft ground coordinated turning system, which may include:

S201, an aircraft ground coordinated turning system is modeled.

The essence of aircraft ground coordinated turning control lies in manipulating the steering angles of the nose wheel and main wheels to ensure that the aircraft moves along a predetermined trajectory. To describe the trajectory tracking problem of aircraft ground coordinated turning, this application introduces a coordinate system.

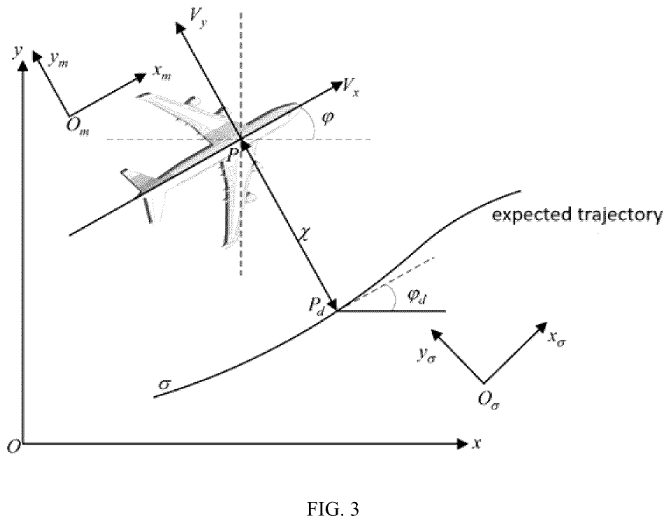

FIG. 3 is a schematic diagram of an aircraft trajectory tracking coordinate system. The aircraft trajectory tracking coordinate system includes a plurality of coordinate systems, and the corresponding Z-axis is omitted in all of them, which can be considered as perpendicular to the paper plane. Wherein, O_{xyz} denotes a globally fixed inertial reference coordinate system (simply referred to as the inertial reference coordinate system), Oₘxₘyₘzₘ denotes an aircraft-body-fixed coordinate system, and O_{σ}x_{σ}y_{σ}z_{σ} denotes a coordinate system defined by a desired trajectory σ. A point P denotes an actual position of the center of gravity of the aircraft, a point P_{d} denotes a desired position of the center of gravity of the aircraft, φ denotes an actual heading angle of the aircraft body relative to the inertial reference coordinate system, φ_{d} denotes a desired heading angle of the aircraft body relative to the inertial reference coordinate system, and χ denotes a yaw distance of the aircraft.

It should be noted that the inertial reference coordinate system is stationary or moving in uniform rectilinear motion relative to stars or distant galaxies. The actual heading angle of the aircraft body relative to the inertial reference coordinate system refers to the direction of the aircraft body during actual flight relative to the earth. The aircraft-body-fixed coordinate system is a three-dimensional orthogonal rectangular coordinate system fixed to the aircraft, following the right-hand rule, with the origin typically located at the center of mass of the aircraft.

A transformation matrix between the inertial reference coordinate system and the aircraft-body-fixed coordinate system is defined and is shown in Equation (1):

$$[ \begin{matrix}{i}_{m} \\ {j}_{m}\end{matrix} ] = [ \begin{matrix}cos {φ}_{e} & sin {φ}_{e} \\ - sin {φ}_{e} & cos {φ}_{e}\end{matrix} ] [ \begin{matrix}{i}_{σ} \\ {j}_{σ}\end{matrix} ] \qquad ( 1 )$$

wherein, φₑ=φ−φ_{d}, φₑ denotes the yaw angle of the aircraft, iₘ and jₘ denote unit vectors in the directions of xₘ-axis and yₘ-axis, respectively, while i_{σ} and j_{σ} denote unit vectors in the directions of x_{σ}-axis and y_{σ}-axis, respectively.

As can be seen from FIG. 3:

$$\vec{{P}_{d}} \cdot \vec{P} = 𝒳 {i}_{σ} \qquad ( 2 )$$

$$\frac{\partial \vec{{OP}_{d}}}{\partial t} = \dot{σ} {i}_{σ}$$

wherein, \dot{σ} denotes a first derivative of the desired trajectory σ with respect to time and t denotes time.

It can be derived from Equation (2):

$$\begin{matrix}\frac{\partial \vec{OP}}{\partial t} = \frac{\partial \vec{{OP}_{d}}}{\partial t} + \frac{\partial \vec{{P}_{d} P}}{\partial t} \\ = \dot{σ} {i}_{σ} + \dot{𝒳} {j}_{σ} - 𝒳 \dot{φ} {i}_{σ} \\ = \dot{σ} ( 1 - 𝒳 c ( σ ) ) {i}_{σ} + \dot{𝒳} {j}_{σ}\end{matrix} \qquad ( 3 )$$

wherein, \dot{χ} denotes a first derivative of χ with respect to time, \dot{φ} denotes a first derivative of φ with respect to time, and c(σ) denotes the curvature of the desired trajectory σ at a position P_{d}.

Equation (2) can likewise be expressed as:

$$\begin{matrix}\frac{\partial \vec{OP}}{\partial t} = {V}_{x} {i}_{m} + {V}_{y} {j}_{m} \\ = ( {V}_{x} cos {φ}_{e} - {V}_{y} sin {φ}_{e} ) {i}_{σ} + ( {V}_{x} sin {φ}_{e} - {V}_{y} cos {φ}_{e} ) {j}_{σ}\end{matrix} \qquad ( 4 )$$

wherein, Vₓ denotes a lateral velocity of the aircraft, and V_{y} denotes a longitudinal velocity of the aircraft. It should be noted that the arrows in Equations (2), (3), and (4) all denote vectors.

It can be derived from Equations (3) and (4):

$$\{ \begin{matrix}\dot{σ} = \frac{{V}_{x} cos {φ}_{e} - {V}_{y} sin {φ}_{e}}{1 - 𝒳 c ( σ )} \\ \dot{𝒳} = {V}_{x} sin {φ}_{e} + {V}_{y} cos {φ}_{e}\end{matrix} \qquad ( 5 )$$

Assuming that the yaw angle of the aircraft is small, i.e. sin φₑ≈φₑ, cos φₑ≈1, Equation (5) can be simplified as:

$$\{ \begin{matrix}\dot{σ} = \frac{{V}_{x} - {V}_{y} {φ}_{e}}{1 - 𝒳 c ( σ )} \\ \dot{𝒳} = {V}_{x} {φ}_{e} + {V}_{y}\end{matrix} \qquad ( 6 )$$

Further, the yaw angle φₑ of the aircraft is derived, then Equation (6) can be expressed as Equation (7):

$$\begin{matrix}\dot{{φ}_{e}} = Ω - \dot{{φ}_{d}} = Ω - \dot{σ} c ( σ ) \\ = Ω - \frac{c ( σ ) ( {V}_{x} - {V}_{y} {φ}_{e} )}{1 - 𝒳 c ( σ )}\end{matrix} \qquad ( 7 )$$

wherein, \dot{φ}ₑ denotes a first derivative of φₑ with respect to time, \dot{φ}_{d} denotes a first derivative of φ_{d} with respect to time, and Ω denotes the yaw angular velocity.

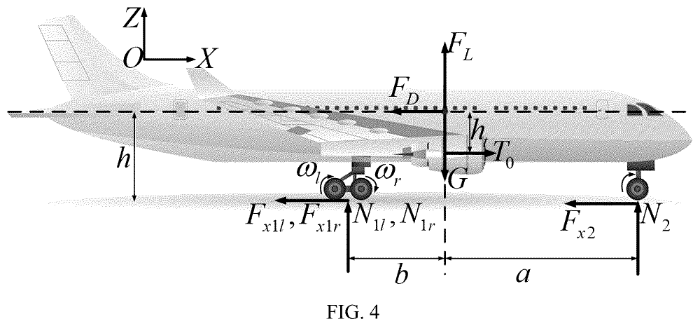

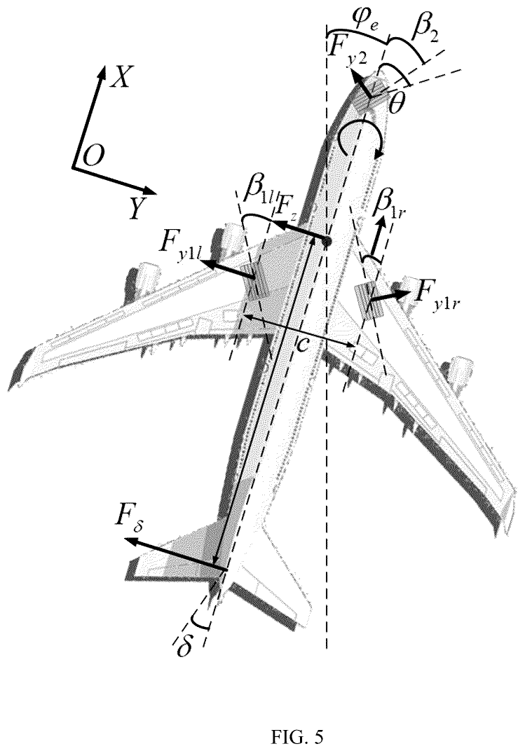

FIG. 4 is a lateral force diagram of aircraft taxiing. FIG. 5 is a top-view force diagram of aircraft taxiing. In FIG. 4, F_{L} denotes lift, F_{D} denotes wind resistance, h denotes a distance from the center of the aircraft body to the ground, hₜ denotes a vertical distance from the residual thrust to the center of gravity, N₁ₗ denotes the supporting force of the ground on the left main wheel, N₁ᵣ denotes the supporting force of the ground on the right main wheel, N₂ denotes the supporting force of the ground on the nose wheel, ωₗ denotes an angular velocity of the left main wheel, ωᵣ denotes an angular velocity of the right main wheel, and G denotes the gravity of the aircraft body. Assuming that the left and right main wheels of the aircraft have the same cornering stiffness and always steer at the same angle, according to the Newton's second law and the law of rigid body rotation, the following can be derived:

$$\{ \begin{matrix}{F}_{δ} - {F}_{y 2} - {F}_{y 1 l} - {F}_{y 1 r} + {F}_{Z} = m {\dot{V}}_{y} + m {V}_{x} Ω \\ {F}_{δ} {b}_{δ} - ( {F}_{y 1 l} + {F}_{y 1 r} ) b + {F}_{y 2} a + ( {F}_{x 1 l} - {F}_{x 1 r} ) \frac{c}{2} = I \dot{Ω}\end{matrix} \qquad ( 8 )$$

wherein, F_{δ} denotes the force of a rudder, F_{y2} denotes the lateral force of the nose wheel, F_{y1l} denotes the lateral force of the left main wheel, F_{y1r} denotes the lateral force of the right main wheel, F_{z} denotes the sidewind disturbance force, m denotes the mass of the aircraft, \dot{V}_{y} denotes a first derivative of V_{y} with respect to time, b_{δ} denotes a projection distance from the rudder to the center of gravity of the aircraft (the distance between F_{z} and F_{δ} in FIG. 2), a denotes a projection distance from the nose wheel to the center of gravity, b denotes a projection distance from the left and right main wheels to the center of gravity, Fₓ₁ₗ denotes the ground reaction force of the left main wheel, Fₓ₁ᵣ denotes the ground reaction force of the right main wheel, c denotes a projection distance between the left and right main wheels, l denotes the moment of inertia of the aircraft, and \dot{Ω} denotes a first derivative of Ω with respect to time.

The ground reaction force Fₓ₁ₗ of the left main wheel and the ground reaction force Fₓ₁ᵣ of the right main wheel can be expressed as:

$$\{ \begin{matrix}{F}_{x 1 l} = {μ}_{l} {N}_{1 l} \\ {F}_{x 1 r} = {μ}_{r} {N}_{1 r}\end{matrix} \qquad ( 9 )$$

wherein, N₁ₗ denotes the supporting force of the left main wheel, N₁ᵣ denotes the supporting force of the right main wheel, μₗ denotes a coefficient of friction for the left main wheel, and μᵣ denotes a coefficient of friction for the right main wheel.

The lateral force F_{y2} of the nose wheel, the lateral force F_{y1l} of the left main wheel, and the lateral force F_{y1r} of the right main wheel can be approximately expressed as:

$$\{ \begin{matrix}{F}_{y 2} = {K}_{n} {β}_{2} \\ {F}_{y 1 l} = {K}_{m} {β}_{1 l} \\ {F}_{y 1 r} = {K}_{m} {β}_{1 r}\end{matrix} \qquad ( 10 )$$

wherein, Kₙ denotes the cornering stiffness of the nose wheel when the sideslip angle is zero, Kₘ denotes the cornering stiffness of the left and right main wheels when the sideslip angle is zero, β₂ denotes the sideslip angle of the nose wheel, β₁ₗ denotes the sideslip angle of the left main wheel, and β₁ᵣ denotes the sideslip angle of the right main wheel.

The sideslip angle of the nose wheel β₂, the sideslip angle of the left main wheel β₁ₗ, and the sideslip angle of the right main wheel β₁ᵣ can be specifically expressed as:

$$\{ \begin{matrix}{β}_{2} = {δ}_{2} - \frac{a Ω}{{V}_{x}} - \frac{{V}_{y}}{{V}_{x}} \\ {β}_{1 l} = {δ}_{1} + \frac{b Ω}{{V}_{x}} - \frac{{V}_{y}}{{V}_{x}} \\ {β}_{1 r} = {δ}_{1} + \frac{b Ω}{{V}_{x}} - \frac{{V}_{y}}{{V}_{x}}\end{matrix} \qquad ( 11 )$$

wherein, δ₂ denotes a steering angle of the nose wheel and δ₁ denotes a steering angle of the left and right main wheels.

The sidewind disturbance force F_{z} and the force of the rudder F_{δ} can be expressed as:

$$\{ \begin{matrix}{F}_{Z} = ρ {SC}_{w} {V}_{wind}^{2} \\ {F}_{δ} = \frac{1}{2} {ρ}_{δ} δ {S}_{δ} {V}_{x}^{2}\end{matrix} \qquad ( 12 )$$

wherein, ρ denotes air density, ρ_{δ} denotes a yaw coefficient of the aircraft, δ denotes a rudder angle, v_{wind} denotes a sidewind velocity, c_{w} denotes a sidewind coefficient, δ denotes a wing area, and s_{δ} denotes a rudder area.

By combining Equations (6), (7), and (8), a model of the aircraft ground coordinated turning system is established:

$$\{ \begin{matrix}\dot{𝒳} = {V}_{x} {φ}_{e} + {V}_{y} \\ \dot{{φ}_{e}} = Ω - \frac{c ( σ ) ( {V}_{x} - {V}_{y} {φ}_{e} )}{1 - 𝒳 c ( σ )} \\ \dot{{V}_{y}} = \frac{{F}_{δ} - 2 {F}_{y δ1} - {F}_{y δ2} + {F}_{z} - m {V}_{x} Ω}{m} - \frac{2 {k}_{m}}{m} {δ}_{1} - \frac{{k}_{n}}{m} {δ}_{2} \\ \dot{Ω} = \frac{{b}_{δ} {F}_{δ} - 2 {bF}_{y δ1} + {aF}_{y δ2} + 0.5 c ( {F}_{x 1 l} - {F}_{x 1 r} )}{I} - \frac{2 {bk}_{m}}{I} {δ}_{1} + \frac{{ak}_{n}}{I} {δ}_{2}\end{matrix} \qquad ( 13 )$$

wherein, F_{yδ1} denotes the force exerted by the rudder on the main wheels, and F_{yδ2} denotes the force exerted by the rudder on the nose wheel.

The force exerted by the rudder on the main wheels F_{yδ1} and the force exerted by the rudder on the nose wheel F_{yδ2} can be expressed as:

$$\{ \begin{matrix}{F}_{y δ2} = - \frac{{k}_{n} ( a Ω + {V}_{y} )}{{V}_{x}} \\ {F}_{y δ1} = \frac{{k}_{m} ( b Ω - {V}_{y} )}{{V}_{x}}\end{matrix} \qquad ( 14 )$$

For the convenience of designing the subsequent aircraft ground coordinated turning controller, Equation (13) can be rewritten in the following form:

$${\dot{x}}_{t} = f ( {x}_{t} ) + {B}_{t} {u}_{t} \qquad ( 15 )$$

wherein, the system state variables xₜ=[χ φₑ V_{y} Ω]^{T}, the system control input

$${u}_{t} = [ \begin{matrix}{δ}_{1} & {{δ}_{2} ]}^{T}\end{matrix} ,$$

$$f ( {x}_{t} ) = {[ \begin{matrix}{f}_{1} ( {x}_{t} ) & {f}_{2} ( {x}_{t} ) & {f}_{3} ( {x}_{t} ) & {f}_{4} ( {x}_{t} )\end{matrix} ]}^{T} ,$$

$${f}_{1} ( {x}_{t} ) = {V}_{x} {φ}_{e} + {V}_{y} ,$$

$${f}_{2} ( {x}_{t} ) = Ω - \frac{c ( σ ) ( {V}_{x} - {V}_{y} {φ}_{e} )}{1 - χ c ( σ )} ,$$

$${f}_{3} ( {x}_{t} ) = \frac{{F}_{δ} - 2 {F}_{y δ1} - {F}_{y δ2} + {F}_{z} - {mV}_{x} Ω}{m} ,$$

$${f}_{4} ( {x}_{t} ) = \frac{{b}_{δ} {F}_{δ} - 2 {bF}_{y δ1} + {aF}_{y δ2} + 0.5 c ( {F}_{x 1 l} - {F}_{x 1 r} )}{I} ,$$

$$and$$

$${B}_{t} = [ \begin{matrix}0 & 0 \\ 0 & 0 \\ - \frac{2 {k}_{m}}{m} & - \frac{{k}_{n}}{m} \\ - \frac{2 {bk}_{m}}{I} & \frac{{ak}_{m}}{I}\end{matrix} ] ,$$

\dot{x}ᵣ denotes the first derivative of xₜ with respect to time.

As an example, the following combination of parameter values can be adopted: m=17256 kg, vₓ=5 m/s, s=50.88 m², ρ=1.225 kg/m², ρs=0.6, I=3120910 kg/m², s_{δ}=12.5 m², a=8.792 m, b=1.014 m, c=4.092 m, Kₙ=15363 N/rad and Kₘ=17747 N/rad.

S202, a composite sliding mode surface for nose-wheel-main-wheel coordinated turning is designed.

During the process of aircraft ground turning, the control target of the aircraft ground coordinated turning system is to enable the aircraft to move along a predetermined trajectory by precisely controlling the steering angles of the nose wheel and main wheels. In other words, aircraft ground coordinated turning control can essentially be regarded as a trajectory tracking control problem.

To achieve precise tracking control of the aircraft trajectory, it is required that the yaw distance χ and yaw angle φₑ of the aircraft approach zero within a relatively short period of time. To this end, the composite sliding mode surface for nose-wheel-main-wheel coordinated turning can be defined as:

$$\{ \begin{matrix}\begin{matrix}{s}_{χ} = {C}_{1} χ + \dot{χ} \\ = {C}_{1} χ + {V}_{x} {φ}_{e} + {V}_{y} \\ = {C}_{1} {x}_{t 3} + {V}_{x} {x}_{t 2} + {x}_{t 4}\end{matrix} \\ \begin{matrix}{s}_{{φ}_{e}} = {C}_{2} {φ}_{e} + {\dot{φ}}_{e} \\ = {C}_{2} {φ}_{e} + Ω - \frac{( {V}_{x} - {V}_{y} {φ}_{e} ) c ( σ )}{1 - χ c ( σ )} \\ = {C}_{2} {x}_{t 2} + {x}_{t 4} - \frac{( {V}_{x} - {x}_{t 2} {x}_{t 3} ) c ( σ )}{1 - c ( σ ) {x}_{t 1}}\end{matrix}\end{matrix} \qquad ( 16 )$$

wherein, S_{χ} denotes a yaw distance sliding mode surface, S_{φ}_{ₑ} denotes a yaw angle sliding mode surface, and c₁ denotes parameters of a yaw distance sliding mode surface to be designed, xₜ₁=χ, xₜ₃=V_{y}, xₜ₂=φₑ, xₜ₄=Ω, c₂ denotes the parameters of a yaw angle sliding mode surface to be designed. The specific values of c₁ and c₂ can both be 10, with the exact values chosen to satisfy the Hurwitz criterion for the aircraft ground coordinated turning system (Hurwitz refers to the Hurwitz stability criterion, which is a mathematical tool).

S203, a nose wheel-main wheel coordinated turning control law is designed.

By taking a derivative of an expression (16) of the composite sliding mode surface for nose-wheel-main-wheel coordinated turning, adopting an exponential approaching rate, and substituting Equation (15) into it, the following Equations can be obtained:

$$\begin{matrix}\begin{matrix}{\dot{s}}_{χ} = {C}_{1} {\dot{x}}_{t 1} + {V}_{x} {\dot{x}}_{t 2} + {\dot{x}}_{t 3} \\ = {C}_{1} {f}_{1} ( {x}_{t} ) + {V}_{x} {f}_{2} ( {x}_{t} ) + {f}_{3} ( {x}_{t} ) - \frac{2 {k}_{m}}{m} {δ}_{1} - \frac{{k}_{n}}{m} {δ}_{2} \\ = {C}_{1} {x}_{t 3} + {V}_{x} {x}_{t 2} + {x}_{t 4} \\ = - 1.1 sgn ( {s}_{χ} ) - 5 {s}_{χ}\end{matrix} \\ \end{matrix} \qquad ( 17 )$$

$$\begin{matrix}{\dot{s}}_{{φ}_{e}} = {C}_{2} {\dot{x}}_{t 2} + {\dot{x}}_{t 4} - \frac{c ( σ ) ( 1 - c ( σ ) {x}_{t 1} ) {( {V}_{x} - {x}_{t 2} {x}_{t 3} )}^{′} - c ( σ ) ( {V}_{x} - {x}_{t 2} {x}_{t 3} ) {( 1 - c ( σ ) {x}_{t 1} )}^{′}}{{( 1 - c ( σ ) {x}_{t 1} )}^{2}} \\ = - \frac{{c ( σ )}^{2} ( {V}_{x} - {x}_{t 2} {x}_{t 3} )}{{( 1 - c ( σ ) {x}_{t 1} )}^{2}} {\dot{x}}_{t 1} + ( {C}_{2} + \frac{c ( σ ) {x}_{t 3}}{1 - c ( σ ) {x}_{t 1}} ) {\dot{x}}_{t 2} + \frac{c ( σ ) {x}_{t 2}}{1 - c ( σ ) {x}_{t 1}} {\dot{x}}_{t 3} + {\dot{x}}_{t 4} \\ = - \frac{{c ( σ )}^{2} ( {V}_{x} - {x}_{t 2} {x}_{t 3} )}{{( 1 - c ( σ ) {x}_{t 1} )}^{2}} {f}_{1} ( {x}_{t} ) + ( {C}_{2} + \frac{c ( σ ) {x}_{t 3}}{1 - c ( σ ) {x}_{t 1}} ) {f}_{2} ( {x}_{t} ) + \frac{c ( σ ) {x}_{t 2}}{1 - c ( σ ) {x}_{t 1}} {f}_{3} ( {x}_{t} ) - \frac{2 {k}_{m} c ( σ ) {x}_{t 3}}{m - mc ( σ ) {x}_{t 2}} {δ}_{1} - \frac{{k}_{n} c ( σ ) {x}_{t 3}}{m - mc ( σ ) {x}_{t 2}} {δ}_{2} + {f}_{4} ( {x}_{t} ) - \frac{2 {bk}_{m}}{I} {δ}_{1} - \frac{{ak}_{n}}{I} {δ}_{2} \\ = - \frac{{c ( σ )}^{2} ( {V}_{x} - {x}_{t 2} {x}_{t 3} )}{{( 1 - c ( σ ) {x}_{t 1} )}^{2}} {f}_{1} ( {x}_{t} ) + ( {C}_{2} + \frac{c ( σ ) {x}_{t 3}}{1 - c ( σ ) {x}_{t 1}} ) {f}_{2} ( {x}_{t} ) + \frac{c ( σ ) {x}_{t 2}}{1 - c ( σ ) {x}_{t 1}} {f}_{3} ( {x}_{t} ) + {f}_{4} ( {x}_{t} ) - ( \frac{2 {k}_{m} c ( σ ) {x}_{t 2}}{m - mc ( σ ) {x}_{t 1}} + \frac{2 {bk}_{m}}{I} ) {δ}_{1} - ( \frac{{k}_{n} c ( σ ) {x}_{t 2}}{m - mc ( σ ) {x}_{t 1}} - \frac{{ak}_{n}}{I} ) {δ}_{2} \\ = - 1.1 sgn ( {s}_{{φ}_{e}} ) - 5 {s}_{{φ}_{e}}\end{matrix} \qquad ( 18 )$$

wherein, \dot{s}ₓ denotes a first derivative of S_{χ} with respect to time, \dot{x}ₜ₁ denotes a first derivative of xₜ₁ with respect to time, \dot{x}ₜ₂ denotes a first derivative of xₜ₂ with respect to time, \dot{x}₁₃ denotes a first derivative of xₜ₃ with respect to time, and \dot{s}_{φ}_{ₑ} denotes a first derivative of S_{φ}_{ₑ} with respect to time.

By combining Equations (17) and (18), the nose wheel-main wheel coordinated turning control law can be obtained as follows:

$$[ \begin{matrix}{δ}_{1} \\ {δ}_{2}\end{matrix} ] = {[ \begin{matrix}- \frac{2 {k}_{m}}{m} & - \frac{{k}_{n}}{m} \\ - ( \frac{2 {k}_{m} c ( σ ) {x}_{t 3}}{m - m c ( σ ) {x}_{t 2}} + \frac{2 {bk}_{m}}{I} ) & - ( \frac{{k}_{n} c ( σ ) {x}_{t 3}}{m - m c ( σ ) {x}_{t 2}} - \frac{{ak}_{n}}{I} )\end{matrix} ]}^{- 1} \cdot [ \text{} \begin{matrix}- 1.1 sgn ( {s}_{χ} ) - 5 {s}_{χ} - {A}_{1} \\ - 1.1 sgn ( {s}_{{φ}_{e}} ) - 5 {s}_{{φ}_{e}} - {A}_{2}\end{matrix} ] \qquad ( 19 )$$

wherein, A₁ denotes a first intermediate parameter and A₂ denotes a second intermediate parameter.

$${A}_{1} = {C}_{1} {f}_{1} ( {x}_{t} ) + {V}_{x} {f}_{2} ( {x}_{t} ) + {f}_{3} ( {x}_{t} )$$

$${A}_{2} = - \frac{{c ( σ )}^{2} ( {V}_{x} - {x}_{t 2} {x}_{t 3} )}{{( 1 - c ( σ ) {x}_{t 1} )}^{2}} {f}_{1} ( {x}_{t} ) + ( {C}_{2} + \frac{c ( σ ) {x}_{t 3}}{1 - c ( σ ) {x}_{t 1}} ) {f}_{2} ( {x}_{t} ) + \frac{c ( σ ) {x}_{t 2}}{1 - c ( σ ) {x}_{t 1}} {f}_{3} ( {x}_{t} ) + {f}_{4} ( {x}_{t} ) .$$

Aircraft ground coordinated turning is controlled according to the control law.

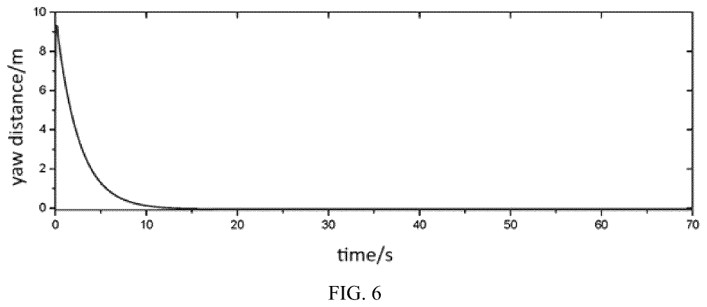

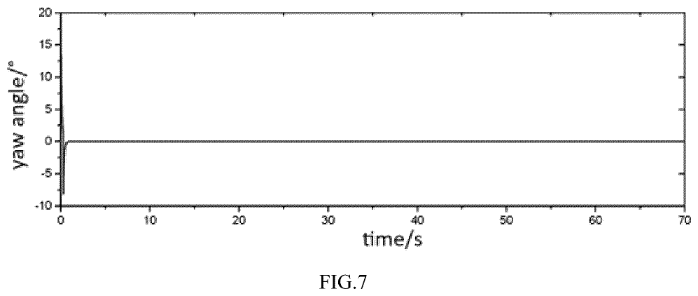

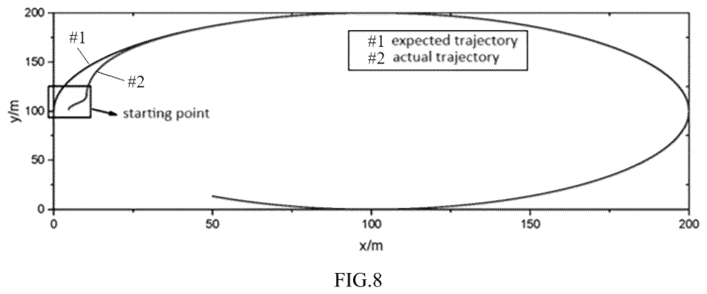

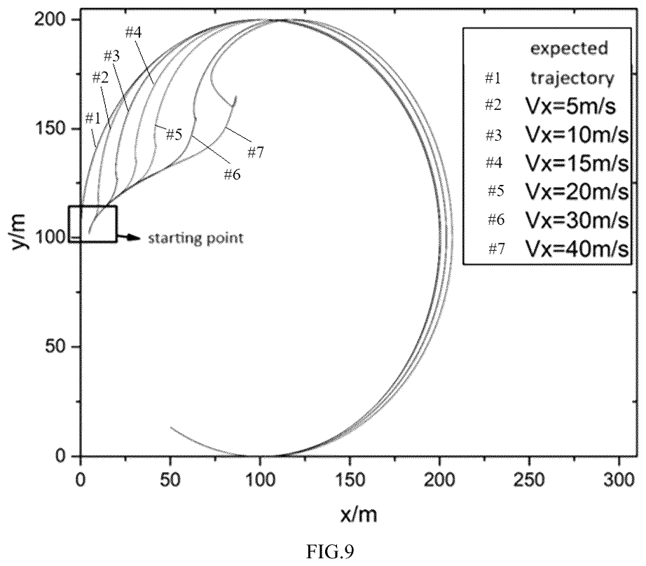

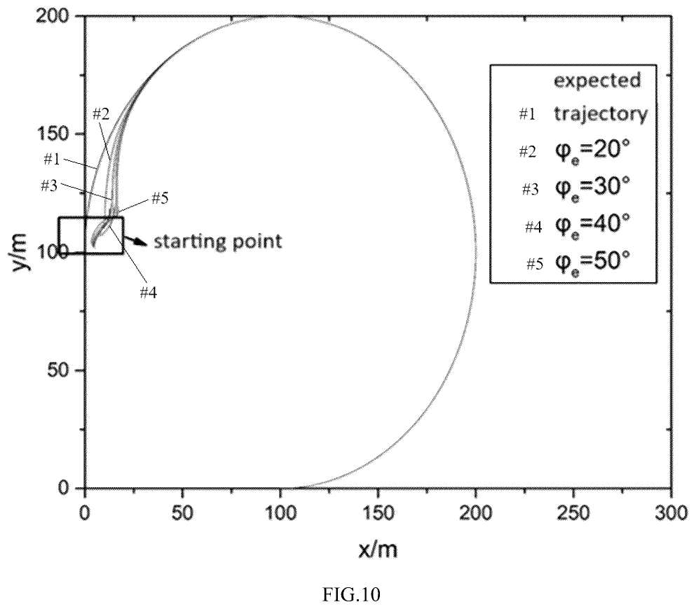

Simulation is conducted using MATLAB software with a sampling time of 0.001 s, and the simulation research results are presented in FIGS. 6 to 10. FIG. 6 is a yaw distance graph for coordinated turning control under fixed initial conditions; FIG. 7 is a yaw angle graph for coordinated turning control of an aircraft under fixed initial conditions; FIG. 8 is a motion trajectory graph for coordinated turning control under fixed initial conditions; FIG. 9 is a trajectory tracking graph for coordinated turning control at different longitudinal speeds; and FIG. 10 is a trajectory tracking graph for coordinated turning control at different initial yaw angles of an aircraft. The fixed initial conditions are set as: a yaw distance of the aircraft is 5 m, a yaw angle of the aircraft is 20°, and a lateral velocity of the aircraft is 5 m/s. FIGS. 6 and 7 indicate that the proposed method can effectively control the yaw distance and yaw angle of the aircraft to near zero within a short period, demonstrating its ability to control the aircraft to taxi along the expected trajectory within a short period. FIG. 8 illustrates that the error in aircraft trajectory tracking eventually approaches to zero, showcasing significant control effectiveness in achieving the intended trajectory tracking. FIG. 9 illustrates that at lower speeds, the aircraft can quickly and accurately track the expected trajectory with minimal tracking error. This underscores the excellent trajectory tracking control performance of the aircraft ground coordinated turning system under low-speed conditions. However, as the longitudinal speed of the aircraft increases, the radius of the ground turning curve significantly enlarges, necessitating more response time for the aircraft ground coordinated turning system to track the expected trajectory. Simultaneously, the corresponding trajectory tracking error gradually increases. Therefore, to enhance the overall control performance of the aircraft ground coordinated turning system during the actual taxiing and turning process, it is necessary to ensure that the aircraft performs taxiing and turning at a lower longitudinal speed. FIG. 10 illustrates that the aircraft ground coordinated turning system can efficiently track the expected trajectory under different initial yaw angles of the aircraft, with the tracking error remaining within a reasonable range.

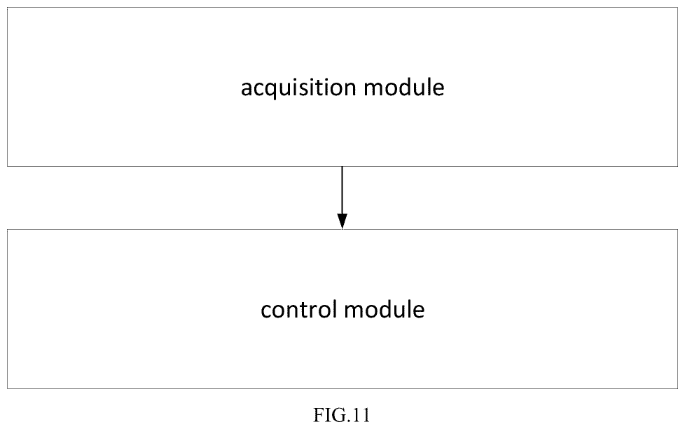

Based on the above sliding mode control method of the aircraft ground coordinated turning system, as shown in FIG. 11, the present application further proposes a sliding mode control system of an aircraft ground coordinated turning system, which may include:
an acquisition module, configured to acquire real-time parameters of an aircraft;
a control module, configured to control a state of the aircraft ground coordinated turning system on a composite sliding mode surface for nose-wheel-main-wheel coordinated turning by a nose-wheel-main-wheel coordinated turning control law based on the real-time parameters of the aircraft; wherein
the state of the aircraft ground coordinated turning system includes a steering angle of a left main wheel and a right main wheel, and a steering angle of a nose wheel;
a control target of the composite sliding mode surface for nose-wheel-main-wheel coordinated turning is that a yaw distance of the aircraft and a yaw angle of the aircraft approach zero within a preset time; and
an acquisition method of the nose-wheel-main-wheel coordinated turning control law includes:
taking a derivative of the composite sliding mode surface for nose-wheel-main-wheel coordinated turning, and in combination with a model of the aircraft ground coordinated turning system, determining a nose-wheel-main-wheel coordinated turning control law; wherein system state variables of the model of the aircraft ground coordinated turning system include a yaw distance of the aircraft, a yaw angle of the aircraft, a longitudinal velocity of the aircraft and a yaw angular velocity.

It should be noted that in several embodiments provided in the present application, it should be understood that the disclosed device and method can be implemented in other ways. For example, the device embodiments described above are merely schematic, for example, the division of each module is only one logical function division, and there may be other division methods in actual implementation, for example, a plurality of modules may be combined or integrated into another device, or some features may be ignored or not executed. The modules described as separate components may or may not be physically separate, and the components displayed as modules may be one physical unit or a plurality of physical units, that is, they may be located at one place or may be distributed to a plurality of different places. Some or all of the modules may be selected according to actual needs to achieve the purpose of the solution of this embodiment.

In addition, in each embodiment of the present disclosure, each module may be integrated in one processing unit, each module may be physically present alone, or two or more modules may be integrated in one unit. The above integrated unit may be implemented in the form of hardware or software functional unit.

In addition, the present application also proposes an aircraft ground coordinated turning system, including a controller and a body of the aircraft ground coordinated turning system; wherein the controller controls the body of the aircraft ground coordinated turning system according to the sliding mode control method of the aircraft ground coordinated turning system.

The foregoing is only the preferred embodiments of the present disclosure and is not intended to limit the present disclosure, and various modifications and variations of the present disclosure will be apparent to those skilled in the art. Any modification, equivalent substitution, improvement, etc. made within the spirit and principle of the present application should be included within the scope of protection of the present application.

What is claimed is:

1. A sliding mode control method of an aircraft ground coordinated turning system, comprising:
acquiring real-time parameters of an aircraft; and
controlling a state of the aircraft ground coordinated turning system on a composite sliding mode surface for nose-wheel-main-wheel coordinated turning by a nose-wheel-main-wheel coordinated turning control law based on the real-time parameters of the aircraft; wherein
the state of the aircraft ground coordinated turning system comprises a steering angle of a left main wheel and a right main wheel, and a steering angle of a nose wheel;
a control target of the composite sliding mode surface for nose-wheel-main-wheel coordinated turning is that a yaw distance of the aircraft and a yaw angle of the aircraft approach zero within a preset time; and
an acquisition method of the nose-wheel-main-wheel coordinated turning control law comprises:
taking a derivative of the composite sliding mode surface for nose-wheel-main-wheel coordinated turning, and in combination with a model of the aircraft ground coordinated turning system, determining a nose-wheel-main-wheel coordinated turning control law; wherein system state variables of the model of the aircraft ground coordinated turning system comprise a yaw distance of the aircraft, a yaw angle of the aircraft, a longitudinal velocity of the aircraft and a yaw angular velocity.

2. The sliding mode control method of an aircraft ground coordinated turning system according to claim 1, wherein the model of the aircraft ground coordinated turning system, the composite sliding mode surface for nose-wheel-main-wheel coordinated turning and the nose-wheel-main-wheel coordinated turning control law are all determined based on an aircraft trajectory tracking coordinate system; and
the aircraft trajectory tracking coordinate system comprises an inertial reference coordinate system, an aircraft-body-fixed coordinate system and a coordinate system defined by a desired trajectory.

3. The sliding mode control method of an aircraft ground coordinated turning system according to claim 2, wherein the model of the aircraft ground coordinated turning system comprises:
$$\{ \begin{matrix}\dot{χ} = - {V}_{x} {φ}_{e} + {V}_{y} \\ {\dot{φ}}_{e} = Ω - \frac{c ( σ ) ( {V}_{x} - {V}_{y} {φ}_{e} )}{1 - χ c ( σ )} \\ {\dot{V}}_{y} = \frac{{F}_{δ} - 2 {F}_{y δ1} - {F}_{y δ2} + {F}_{z} - {mV}_{x} Ω}{m} - \frac{2 {k}_{m}}{m} {δ}_{1} - \frac{{k}_{n}}{m} {δ}_{2} \\ \dot{Ω} = \frac{{b}_{δ} {F}_{δ} - 2 {bF}_{y δ1} + {aF}_{y δ2} + 0.5 c ( {F}_{x 1 l} - {F}_{x 1 r} )}{I} - \frac{2 {bk}_{m}}{I} {δ}_{1} + \frac{{ak}_{n}}{I} {δ}_{2}\end{matrix}$$
wherein, \dot{χ} denotes a first derivative of χ with respect to time, Vₓ denotes a lateral velocity of the aircraft, φₑ denotes a yaw angle of the aircraft, V_{y} denotes a longitudinal velocity of the aircraft, \dot{φ}ₑ denotes a first derivative of φₑ with respect to time, Ω denotes a yaw angular velocity, c(σ) denotes the curvature of a desired trajectory σ at a position P_{d}, P_{d} denotes a desired position of the center of gravity of the aircraft, χ denotes a yaw distance of the aircraft, \dot{V}_{y} denotes a first derivative of V_{y} with respect to time, F_{δ} denotes the force of a rudder, F_{yδ1} denotes the force exerted by the rudder on the main wheels, F_{yδ2} denotes the force exerted by the rudder on the nose wheel, F_{z} denotes the sidewind disturbance force, m denotes the mass of the aircraft, kₘ denotes the cornering stiffness of the left and right main wheels when a sideslip angle is zero, δ₁ denotes a steering angle of the left and right main wheels, kₙ denotes the cornering stiffness of the nose wheel when the sideslip angle is zero, δ₂ denotes a steering angle of the nose wheel, \dot{Ω} denotes a first derivative of Ω with respect to time, b_{δ} denotes a projection distance from the rudder to the center of gravity of the aircraft, b denotes a projection distance from the left and right main wheels to the center of gravity of the aircraft, A denotes a projection distance from the nose wheel to the center of gravity of the aircraft, c denotes a projection distance between the left and right main wheels, l denotes the moment of inertia of the aircraft, Fₓ₁ₗ denotes the ground reaction force of the left main wheel, and Fₓ₁ᵣ denotes the ground reaction force of the right main wheel.

4. The sliding mode control method of an aircraft ground coordinated turning system according to claim 3, wherein the composite sliding mode surface for nose-wheel-main-wheel coordinated turning comprises:
$$\{ \begin{matrix}\begin{matrix}{s}_{χ} = {C}_{1} χ + \dot{χ} \\ = {C}_{1} χ + {V}_{x} {φ}_{e} + {V}_{y} \\ = {C}_{1} {x}_{t 3} + {V}_{x} {x}_{t 2} + {x}_{t 4}\end{matrix} \\ \begin{matrix}{s}_{{φ}_{e}} = {C}_{2} {φ}_{e} + {\dot{φ}}_{e} \\ = {C}_{2} {φ}_{e} + Ω - \frac{( {V}_{x} - {V}_{y} {φ}_{e} ) c ( σ )}{1 - χ c ( σ )} \\ = {C}_{2} {x}_{t 2} + {x}_{t 4} - \frac{( {V}_{x} - {x}_{t 2} {x}_{t 3} ) c ( σ )}{1 - c ( σ ) {x}_{t 1}}\end{matrix}\end{matrix}$$
wherein, S_{χ} denotes a yaw distance sliding mode surface, S_{φ}_{ₑ} denotes a yaw angle sliding mode surface, c₁ denotes parameters of a yaw distance sliding mode surface to be designed, xₜ₁=χ, xₜ₃=V_{y}, xₜ₂=φₑ, xₜ₄=Ω, c₂ denote the parameters of a yaw angle sliding mode surface to be designed.

5. The sliding mode control method of an aircraft ground coordinated turning system according to claim 4, wherein the nose-wheel-main-wheel coordinated turning control law comprises:
$$[ \begin{matrix}{δ}_{1} \\ {δ}_{2}\end{matrix} ] = {[ \begin{matrix}- \frac{2 {k}_{m}}{m} & - \frac{{k}_{n}}{m} \\ - ( \frac{2 {k}_{m} c ( σ ) {x}_{t 3}}{m - m c ( σ ) {x}_{t 2}} + \frac{2 {bk}_{m}}{I} ) & - ( \frac{{k}_{n} c ( σ ) {x}_{t 3}}{m - m c ( σ ) {x}_{t 2}} - \frac{{ak}_{n}}{I} )\end{matrix} ]}^{- 1} \cdot [ \text{} \begin{matrix}- 1.1 sgn ( {s}_{χ} ) - 5 {s}_{χ} - {A}_{1} \\ - 1.1 sgn ( {s}_{{φ}_{e}} ) - 5 {s}_{{φ}_{e}} - {A}_{2}\end{matrix} ]$$
wherein, A₁ denotes a first intermediate parameter, A₂ denotes a second intermediate parameter, s_{χ} denotes a yaw distance sliding mode surface, and s_{φ}_{ₑ} denotes a yaw angle sliding mode surface;
$${A}_{1} = {C}_{1} {f}_{1} ( {x}_{t} ) + {V}_{x} {f}_{2} ( {x}_{t} ) + {f}_{3} ( {x}_{t} )$$
$${A}_{2} = - \frac{{c ( σ )}^{2} ( {V}_{x} - {x}_{t 2} {x}_{t 3} )}{{( 1 - c ( σ ) {x}_{t 1} )}^{2}} {f}_{1} ( {x}_{t} ) + ( {C}_{2} + \frac{c ( σ ) {x}_{t 3}}{1 - c ( σ ) {x}_{t 1}} ) {f}_{2} ( {x}_{t} ) + \frac{c ( σ ) {x}_{t 2}}{1 - c ( σ ) {x}_{t 1}} {f}_{3} ( {x}_{t} ) + {f}_{4} ( {x}_{t} )$$
$$wherein ,$$
$${f}_{1} ( {x}_{t} ) = {V}_{x} {φ}_{e} + {V}_{y} ,$$
$${f}_{2} ( {x}_{t} ) = Ω - \frac{c ( σ ) ( {V}_{x} - {V}_{y} {φ}_{e} )}{1 - χ c ( σ )} ,$$
$${f}_{3} ( {x}_{t} ) = \frac{{F}_{δ} - 2 {F}_{y δ1} + {F}_{y δ2} + {F}_{z} - {mV}_{x} Ω}{m} ,$$
$${f}_{4} ( {x}_{t} ) = \frac{{b}_{δ} {F}_{δ} - 2 {bF}_{y δ1} + {aF}_{y δ2} + 0.5 c ( {F}_{x 1 l} - {F}_{x 1 r} )}{I} .$$

6. A sliding mode control system of an aircraft ground coordinated turning system, comprising:
an acquisition module, configured to acquire real-time parameters of an aircraft;
a control module, configured to control a state of the aircraft ground coordinated turning system on a composite sliding mode surface for nose-wheel-main-wheel coordinated turning by a nose-wheel-main-wheel coordinated turning control law based on the real-time parameters of the aircraft; wherein
the state of the aircraft ground coordinated turning system comprises a steering angle of a left main wheel and a right main wheel, and a steering angle of a nose wheel;
a control target of the composite sliding mode surface for nose-wheel-main-wheel coordinated turning is that a yaw distance of the aircraft and a yaw angle of the aircraft approach zero within a preset time; and
an acquisition method of the nose-wheel-main-wheel coordinated turning control law comprises:
taking a derivative of the composite sliding mode surface for nose-wheel-main-wheel coordinated turning, and in combination with a model of the aircraft ground coordinated turning system, determining a nose-wheel-main-wheel coordinated turning control law; wherein system state variables of the model of the aircraft ground coordinated turning system comprise a yaw distance of the aircraft, a yaw angle of the aircraft, a longitudinal velocity of the aircraft and a yaw angular velocity.

7. The sliding mode control system of an aircraft ground coordinated turning system according to claim 6, wherein the model of the aircraft ground coordinated turning system, the composite sliding mode surface for nose-wheel-main-wheel coordinated turning and the nose-wheel-main-wheel coordinated turning control law are all determined based on an aircraft trajectory tracking coordinate system; and
the aircraft trajectory tracking coordinate system comprises an inertial reference coordinate system, an aircraft-body-fixed coordinate system and a coordinate system defined by a desired trajectory.

8. The sliding mode control system of an aircraft ground coordinated turning system according to claim 7, wherein the model of the aircraft ground coordinated turning system comprises:
$$\{ \begin{matrix}\dot{χ} = - {V}_{x} {φ}_{e} + {V}_{y} \\ {\dot{φ}}_{e} = Ω - \frac{c ( σ ) ( {V}_{x} - {V}_{y} {φ}_{e} )}{1 - χ c ( σ )} \\ {\dot{V}}_{y} = \frac{{F}_{δ} - 2 {F}_{y δ1} - {F}_{y δ2} + {F}_{z} - {mV}_{x} Ω}{m} - \frac{2 {k}_{m}}{m} {δ}_{1} - \frac{{k}_{n}}{m} {δ}_{2} \\ \dot{Ω} = \frac{{b}_{δ} {F}_{δ} - 2 {bF}_{y δ1} + {aF}_{y δ2} + 0.5 c ( {F}_{x 1 l} - {F}_{x 1 r} )}{I} - \frac{2 {bk}_{m}}{I} {δ}_{1} + \frac{{ak}_{n}}{I} {δ}_{2}\end{matrix}$$
wherein, \dot{χ} denotes a first derivative of χ with respect to time, Vₓ denotes a lateral velocity of the aircraft, φₑ denotes a yaw angle of the aircraft, V_{y} denotes a longitudinal velocity of the aircraft, \dot{φ}ₑ denotes a first derivative of φₑ with respect to time, Ω denotes a yaw angular velocity, c(σ) denotes the curvature of a desired trajectory σ at a position P_{d}, P_{d} denotes a desired position of the center of gravity of the aircraft, χ denotes a yaw distance of the aircraft, \dot{V}_{y} denotes a first derivative of V_{y} with respect to time, F_{δ} denotes the force of a rudder, F_{yδ1} denotes the force exerted by the rudder on the main wheels, F_{yδ2} denotes the force exerted by the rudder on the nose wheel, F_{z} denotes the sidewind disturbance force, m denotes the mass of the aircraft, kₘ denotes the cornering stiffness of the left and right main wheels when the sideslip angle is zero, δ₁ denotes a steering angle of the left and right main wheels, kₙ denotes the cornering stiffness of the nose wheel when the sideslip angle is zero, δ₂ denotes a steering angle of the nose wheel, \dot{Ω} denotes a first derivative of Ω with respect to time, b_{δ} denotes a projection distance from the rudder to the center of gravity of the aircraft, b denotes a projection distance from the left and right main wheels to the center of gravity of the aircraft, A denotes a projection distance from the nose wheel to the center of gravity of the aircraft, c denotes a projection distance between the left and right main wheels, l denotes the moment of inertia of the aircraft, Fₓ₁ₗ denotes the ground reaction force of the left main wheel, and Fₓ₁ᵣ denotes the ground reaction force of the right main wheel.

9. The sliding mode control system of an aircraft ground coordinated turning system according to claim 8, wherein the composite sliding mode surface for nose-wheel-main-wheel coordinated turning comprises:
$$\{ \begin{matrix}\begin{matrix}{s}_{χ} = {C}_{1} χ + \dot{χ} \\ = {C}_{1} χ + {V}_{x} {φ}_{e} + {V}_{y} \\ = {C}_{1} {x}_{t 3} + {V}_{x} {x}_{t 2} + {x}_{t 4}\end{matrix} \\ \begin{matrix}{s}_{{φ}_{e}} = {C}_{2} {φ}_{e} + {\dot{φ}}_{e} \\ = {C}_{2} {φ}_{e} + Ω - \frac{( {V}_{x} - {V}_{y} {φ}_{e} ) c ( σ )}{1 - χ c ( σ )} \\ = {C}_{2} {x}_{t 2} + {x}_{t 4} - \frac{( {V}_{x} - {x}_{t 2} {x}_{t 3} ) c ( σ )}{1 - c ( σ ) {x}_{t 1}}\end{matrix}\end{matrix}$$
wherein, S_{χ} denotes a yaw distance sliding mode surface, S_{φ}_{ₑ} denotes a yaw angle sliding mode surface, c₁ denotes parameters of a yaw distance sliding mode surface to be designed, xₜ₁=χ, xₜ₃=V_{y}, xₜ₂=φₑ, xₜ₄=Ω, c₂ denote the parameters of a yaw angle sliding mode surface to be designed;
the nose-wheel-main-wheel coordinated turning control law comprises:
$$[ \begin{matrix}{δ}_{1} \\ {δ}_{2}\end{matrix} ] = {[ \begin{matrix}- \frac{2 {k}_{m}}{m} & - \frac{{k}_{n}}{m} \\ - ( \frac{2 {k}_{m} c ( σ ) {x}_{t 3}}{m - m c ( σ ) {x}_{t 2}} + \frac{2 {bk}_{m}}{I} ) & - ( \frac{{k}_{n} c ( σ ) {x}_{t 3}}{m - m c ( σ ) {x}_{t 2}} - \frac{{ak}_{m}}{I} )\end{matrix} ]}^{- 1} \cdot [ \text{} \begin{matrix}- 1.1 sgn ( {s}_{χ} ) - 5 {s}_{χ} - {A}_{1} \\ - 1.1 sgn ( {s}_{{φ}_{e}} ) - 5 {s}_{{φ}_{e}} - {A}_{2}\end{matrix} ]$$
wherein, A₁ denotes a first intermediate parameter, A₂ denotes a second intermediate parameter, S_{χ} denotes a yaw distance sliding mode surface, and S_{φ}_{ₑ} denotes a yaw angle sliding mode surface;
$${A}_{1} = {C}_{1} {f}_{1} ( {x}_{t} ) + {V}_{x} {f}_{2} ( {x}_{t} ) + {f}_{3} ( {x}_{t} )$$
$${A}_{2} = - \frac{{c ( σ )}^{2} ( {V}_{x} - {x}_{t 2} {x}_{t 3} )}{{( 1 - c ( σ ) {x}_{t 1} )}^{2}} {f}_{1} ( {x}_{t} ) + ( {C}_{2} + \frac{c ( σ ) {x}_{t 3}}{1 - c ( σ ) {x}_{t 1}} ) {f}_{2} ( {x}_{t} ) + \frac{c ( σ ) {x}_{t 2}}{1 - c ( σ ) {x}_{t 1}} {f}_{3} ( {x}_{t} ) + {f}_{4} ( {x}_{t} )$$
$$wherein ,$$
$${f}_{1} ( {x}_{t} ) = {V}_{x} {φ}_{e} + {V}_{y} ,$$
$${f}_{2} ( {x}_{t} ) = Ω - \frac{c ( σ ) ( {V}_{x} - {V}_{y} {φ}_{e} )}{1 - χ c ( σ )} ,$$
$${f}_{3} ( {x}_{t} ) = \frac{{F}_{δ} - 2 {F}_{y δ1} - {F}_{y δ2} + {F}_{z} - {mV}_{x} Ω}{m} ,$$
$${f}_{4} ( {x}_{t} ) = \frac{{b}_{δ} {F}_{δ} - 2 {bF}_{y δ1} + {aF}_{y δ2} + 0.5 c ( {F}_{x 1 l} - {F}_{x 1 r} )}{I} .$$

10. An aircraft ground coordinated turning system, comprising a controller and a body of the aircraft ground coordinated turning system; wherein the controller controls the body of the aircraft ground coordinated turning system according to the sliding mode control method of an aircraft ground coordinated turning system according to claim 1.
